(19) United States
(12) Patent Application Publication
(10) Pub. No.: US 2014/0052662 A1
(43) Pub. Date: Feb. 20, 2014

(54) EFFICIENT MANAGEMENT OF OFFSITE DATA STORAGE

(71) Applicant: IRON MOUNTAIN INCORPORATED, Boston, MA (US)

(72) Inventor: Geoffrey Nesnow, Warwick, RI (US)

(73) Assignee: IRON MOUNTAIN INCORPORATED, Boston, MA (US)

(21) Appl. No.: 13/724,678

(22) Filed: Dec. 21, 2012

Related U.S. Application Data
(60) Provisional application No. 61/684,209, filed on Aug. 17, 2012.

(51) Int. Cl. G06Q 10/08

(52) U.S. Cl. CPC G06Q 10/083
USPC 705/340; 705/330

(57) ABSTRACT

An improved technique for managing offsite data storage avoids the need for tapes or other media arriving at an offsite storage location to be mounted. The improved technique includes generating a list of data objects stored on each piece of media of a first set of media sent from a first site to a second site. A reply list is generated, which identifies any data objects that did not arrive at the second site. The missing data objects are stored on a second set of media being prepared for shipment from the first site to the second site. The second set of media typically contains not only the missing data objects, but also additional data objects.

This application claims the benefit of provisional application No. 61/684,209, filed Aug. 17, 2012, which is hereby incorporated by reference in its entirety.

### BACKGROUND

Corporations, government agencies, hospitals, and many other organizations commonly use offsite data storage for securely housing large amounts of data. In a common scenario, data objects, such as files, are ingested at a customer site and stored in a local disk cache, where they are accessible to users via a file system.

The data objects stored in the disk cache are copied onto tape, or other portable storage media, which is physically transported, e.g., via truck, train, plane, etc., to an offsite storage location while a list of what's contained on the media is typically only stored at the site where the media is created. Sometimes, two or more tapes are made, each holding a different copy of the data objects, and the different tapes are shipped to different offsite locations for safekeeping. Providing different copies at different locations ensures that data objects are not lost even if the tape at one of the offsite locations is lost or damaged. In other cases, the off-site copies serve solely as a backup or redundant copy of the data that is stored onsite on disk or other online media.

Typically, to confirm receipt of objects on transport media from the customer site, each offsite location, upon receiving a tape from the customer site, loads the tape or other media into a drive or a “robot,” i.e., an automated means for managing tapes in a storage library. The robot mounts the tape, reads the tape, and confirms that each of the data objects specified on the list of objects has been received. To do this typically requires reading the entire media.

Once safe arrival of a data object at one or more offsite locations has been confirmed, the data object at the customer site can be “stubbed,” i.e., replaced with a pointer to the data object at a respective offsite location. The data object can then be purged from the disk cache at the customer site. Users can continue to access stubbed data objects, albeit usually with some delay, with robots at respective storage sites accessing corresponding tapes from their libraries and loading them into tape drives for reading.

### SUMMARY

The above-described conventional approach has proven to be highly reliable. Unfortunately, however, it has also proven to be expensive. In particular, the need to mount and read each tape received from a customer site is time consuming. Mounting and reading a tape generally requires a robot to load the tape into a tape drive, advance through the tape, and read the tape to ensure that each individual data object it expects to find is, in fact, present. For storage sites that receive a large number of tapes each day, the need to mount and read each tape requires high utilization of robots and may require that additional robots be purchased to handle the workload. Extra robots come at substantial additional cost, and further costs are incurred to power, cool, and maintain the robots. Also, the need to read each tape involves substantial labor, with personnel at storage sites spending a substantial amount of their time verifying tape contents. Some prior implementations avoid the need to mount and read each tape by supplying multiple copies, with the rational being that confirming actual arrival is not necessary if the storage system has enough redundancy. Providing the required level of redundancy can itself be expensive, however.

In contrast with the conventional approach, an improved technique for managing offsite data storage avoids the requirement for tapes or other media arriving at an offsite storage location to be mounted. The improved technique includes generating a list of data objects stored on a first set of media sent or to be sent from a first site to a second site. The list of data objects associates each piece of media with the data objects stored on that piece of media. At the second site, each piece of media is checked in, e.g., by scanning a barcode or other identifier on the piece of media and/or its container. A reply list is generated, which identifies any missing data objects. Missing data objects are identified, without the need to mount the media at the second site, as data objects associated with absent or observably damaged pieces of media. The missing data objects, as indicated on the reply list, are stored on a second set of media being prepared for shipment from the first site to the second site. The second set of media typically contains not only the missing data objects, but also additional data objects. In some examples, storing the missing data objects on the second set of media does not require that any additional pieces of media be used than would be required to store only the additional data objects. Thus, rather than replacing the missing media, the improved technique instead aims at replacing the missing data objects, without using additional pieces of media where possible. The improved technique thus provides better utilization of media in addition to avoiding the need for media to be mounted at the second site. Costs of operating offsite storage locations are therefore reduced. It also simplifies the workflow, reducing errors and labor costs.

Certain embodiments are directed to a method of managing shipments of data storage media between different sites. The method includes generating a list of data objects stored on a first set of media, the list of data objects identifying, for each data object, the particular piece of media of the first set of media on which the respective data object is stored. The method further includes sending, via physical transportation, the first set of media from a first site to a second site. The method still further includes receiving a reply list that indicates which data objects from the list of data objects were missing at the second site, based on which pieces of media of the first set of media did not arrive at the second site or arrived but in an observably damaged condition. The method yet further includes storing, on a second set of media to be physically transported from the first site to the second site, additional data objects, as well as each data object indicated as missing in the received reply list.

Other embodiments are directed to computerized apparatus and computer program products. Some embodiments involve activity that is performed at a single location, while other embodiments involve activity that is distributed over a computerized environment (e.g., over a network).

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same parts throughout the different views. In the accompanying drawings,

FIG. 1 is a block diagram of an example environment, including, inter alia, a first site, a second site, and a third site, in which improved techniques for managing offsite data storage are practiced;

FIG. 2 is a block diagram of an example first site of FIG. 1;

FIG. 3 is a block diagram of an example second site of FIG. 1;

FIG. 4 is a flow chart of an example process for managing offsite storage in the environment of FIG. 1; and

FIG. 5 is a block diagram of the example environment of FIG. 1, in which storage media are cycled between the first site and the second site until they are filled.

### DETAILED DESCRIPTION OF THE INVENTION

Embodiments of the invention will now be described. It is understood that such embodiments are provided by way of example to illustrate various features and principles of the invention, and that the invention hereof is not limited to the specific example embodiments disclosed.

An improved technique for managing offsite data storage avoids the requirement that media arriving at an off-site location be mounted.

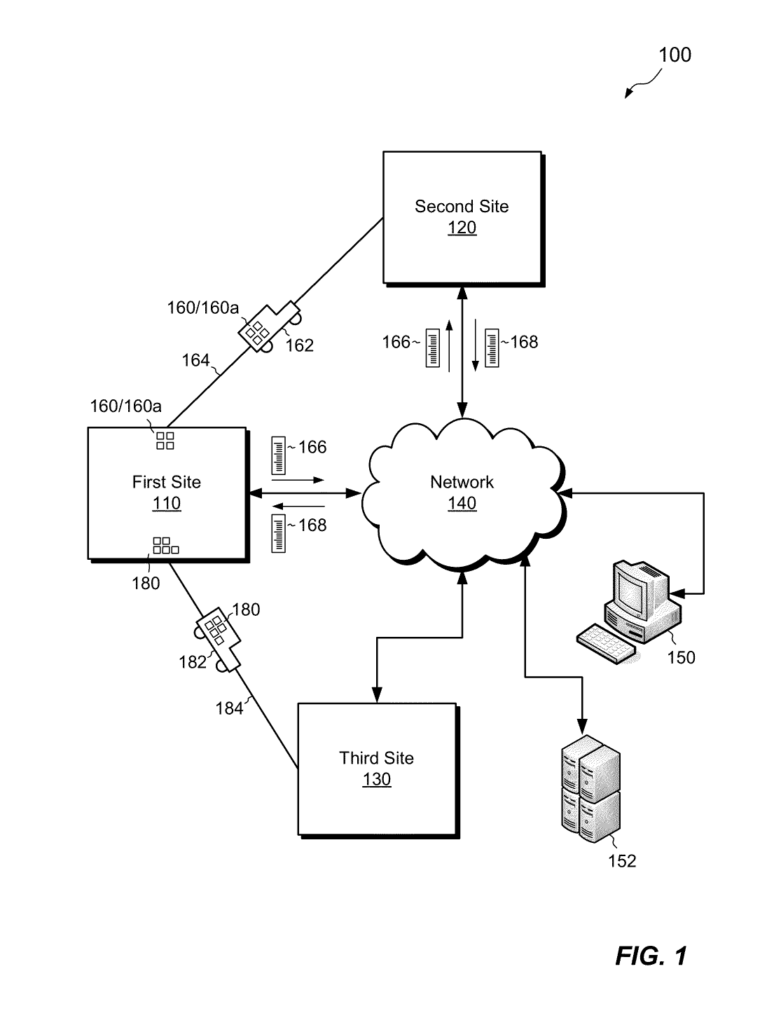

FIG. 1 shows an example environment 100 in which improved techniques for managing offsite data storage are practiced. As shown, a first site 110 produces media for offsite storage at a second site 120 and at a third site 130. For example, the first site 110 stores ingested data objects on a first set of media 160 (i.e., one or more tapes or other pieces of media), which are transported by a truck 162 to the second site 120 along a route 164. Similarly, the first site 110 may store data objects on another set of media 180, which are transported to the third site 130 via a truck 182 along a route 184. The media 180 may include redundant copies of the data objects stored on the first set of media 160, to ensure that data objects can be recovered even if loss or damage occurs at the second site 120. In some examples, additional sites are provided (not shown), for storing additional redundant copies of customer data objects.

In an example, the first site 110, the second site 120, and the third site 130 are each connected to a network 140 for facilitating electronic communication among the first, second, and third sites. One or more user machines 150 are also connected to the network 140, to allow users to access data objects, view the movement of media between sites, and perform other functions. In some examples, a database server 152 is also connected to the network 140. The database server 152 houses a database for keeping track of media and data objects shipped among different sites. Although the database server 152 is shown separate from the first site 110, the second site 120, and the third site 130, it is understood that the database server 152 can be provided at any of the sites 110, 120, and 130, at some other site, or independently. The network 140 is typically the Internet, but can be any type of network supporting digital communication, such as a Wide Area Network (WAN), telephone network, cellular network, microwave network, or any other type of network or combination of networks.

In some examples, the first site 110 is a customer site, where data objects for offsite storage are ingested and the second site 120 and third site 130 are offsite storage locations, such as data vaults. Data vaults are typically secure locations, which may be maintained under constant environmental conditions, for safely preserving media that store customer data objects for long periods of time.

The first site 110 typically stores newly received data objects locally, such as on a local disk cache. The data objects can be any types of data, programs, directory structures, attributes, or other software or settings, and are generally particular to the customer's business. If the customer is a hospital, for example, the data objects might be patient X-rays or MRI data. The data objects stored on the disk cache are generally accessible to user machines 150 via a file system or an application that interfaces with the file system.

In addition to being stored on the disk cache, the ingested data objects are also written to storage media, such as tapes. The data objects are typically stored on two or more different media, such as the first set of media 160 and the additional set of media 180. In addition to tapes, storage media can include portable disk drives, optical media, such as CDs, DVDs, Blu-Ray disks, magneto-optical media, and/or other types of media, for example.

A customer that operates the first site 110 typically has a disaster recovery (DR) policy, which requires that new data objects be stored offsite soon after ingestion. In an example, a shipment of newly ingested data objects can be made from the first site 110 to the second site 120 (e.g., via the truck 162) on a regular basis, such as daily, semi-daily, weekly, or on some other time interval basis, as required by the DR policy. Because shipments from the first site 110 to the second site 120 are made based on time, it is generally the case that the first set of media 160 are incompletely filled at the time of shipment. In some cases, the media 160 may consist of only a single tape, and that tape might be mostly empty.

Although the second site 120 typically receives partially filled media, the third site 130 is typically less constrained by DR requirements and receives substantially filled media. In general, shipments from the first site 110 to the third site 130 take place only after the set of media 180 is filled.

In some examples, the second site 120 performs the role of an “active site,” whereas the third site 130 performs the role of a “passive site.” The active site generally includes media readers that allow user machines 150 to access data objects from stored media via the file system, albeit typically with some delay, whereas the passive site generally merely provides cold storage, essentially acting as backup for the data objects stored at the active site. Optionally, the passive site and active site could be converted to 2 active, load balancing sites—simultaneously serving requests for different customers.

In operation, data objects are ingested at the first site 110 and dual-written to tape or other media, such that all objects will exist on two distinct tapes or other media. One copy is slated to be shipped with the first set of media 160 to the second site 120 at a predetermined time (e.g. the next day, as prescribed by the DR policy), whereas the other copy is slated to be shipped with the media 180 when the media 180 are full and after confirmation of successful receipt of a copy of the objects at the second site. Each piece of media is typically labeled on its exterior (and/or on a container for the media) with a media identifier, such as a GUID (globally unique identifier). The media identifier can be rendered as a barcode to facilitate convenient tracking.

Contemporaneously with shipping the first set of media 160, the first site 110 generates a list 166 of the data objects stored on the first set of media 160. The list 166 is preferably generated electronically and includes the media identifier for each piece of media (e.g., each tape) included in the first set of media 160. For each media identifier listed, the list 166 includes the identifier (e.g., file name) of each data object stored on the respective identified piece of media. In an example, the list 166 of data objects is provided in the form of an XML (extended markup language) file.

In some examples, the list 166 of data objects is transmitted to the second site 120, e.g., over the network 140. The second site 120 receives the list 166 over the network 140, and contemporaneously also receives the first set of media 160 itself, e.g., via the truck 162 at a loading dock or via some other form of delivery.

At the second site 120, the contents of the first set of media 160 are inspected. For example, the media identifier of each piece of media (e.g., each tape) of the arriving set of media 160 is scanned and checked against the media identifiers on the list 166 of data objects. When a media identifier is scanned from the arriving first set of media 160, all the data objects associated with that media identifier on the list 166 are deemed to have arrived safely. However, if the list 166 includes media identifiers for which no matching identifiers are scanned in the arriving first set of media 160, the media associated with those missing media identifiers are deemed to be missing. Also, any media arriving in an observably damaged condition, i.e., that extends beyond mere cosmetic damage and suggests the media may be unreadable or unreliable, are treated as missing. Personnel may be trained not to scan such damaged media, or to scan them but to indicate a damaged condition such that they are treated the same as missing media. Further, each of the data objects listed on the list 166 in connection with the missing or observably damaged media are themselves deemed to be missing.

In some examples, all pieces of media of the first set of media 160 are transported from the first site 110 to the second site 120 in a single shipment, meaning all at once and all together, such as on a single truck or in a single shipped package. In such circumstances, the absence of any pieces of media from the first set of media 160 can be readily ascertained, as the media are either part of the shipment or they are not. In other examples, different pieces of media that make up the first set of media 160 are transported from the first site 110 to the second site 120 over multiple designated shipments. Here, media from the different shipments are logically grouped together at the second site 120 and missing media are identified as any media from the list 166 that are missing once all designated shipments arrive. In yet other examples, the pieces of media that make up the first set of media 160 are allowed to be transmitted in any shipments from the first site 110 to the second site 120 over a designated window of time. The designated window of time may be based on any suitable reference point, such as the time a first piece of media of the set of media 160 is loaded onto a truck for shipment. In an example, the list 166 of data objects includes a timestamp, indicating the beginning of the window of time, and an expiration date, indicating when the designated window of time closes. Pieces of media identified on the list 166 as belonging to the first set of media 160 that do not arrive at the second site 120 in any shipment during the specified window of time are deemed to be missing, as are all the data objects such missing media contain.

In some examples, in response to scanning media identifiers of the arriving first set of media 160, the second site 120 generates a reply list 168. The reply list 168 includes a reference to each data object from the list 166 that has been deemed to be missing, i.e., by virtue of the media identifier associated with the respective data object not having been scanned or the media arriving in a visibly damaged condition. The reply list 168 may also include a list of all data objects from the list 166 whose arrival at the second site 120 has been confirmed, i.e., by virtue of the media identifier associated with the respective data object being scanned and not indicated as damaged. The reply list 168 may thus be a version of the original list 166, which is modified to indicate which data objects have arrived safely and which are missing.

It is expected that media may sometimes be shipped from the first site 110 to the second site 120 by mistake or otherwise not as part of the first set of media 160. In these examples, the reply list 166 can be made to include identifiers of the extra media. Appropriate action can then be taken, such as to request instructions of the owner of the extra media, instruct the second site 120 to send the extra media back to the first site 110, instruct the second site 120 to store the extra media at the second site 120, send them to some other site, destroy those media or take other action.

The reply list 168 is then sent back to the first site 110, e.g., over the network 140. The first site 110 receives and processes the reply list 168. For each data object identified on the reply list 168 as missing from the shipment to the second site 120, the first site 110 proceeds to copy the missing data object (which still typically remains on disk at the first site 110) onto media already being prepared for shipment to the second site 120, i.e., on a second set of media 160a. The second set of media 160a typically includes data objects that have been newly ingested at the first site 110, as well as the missing data objects from the earlier shipment. The second set of media 160a is then shipped to the second site in accordance with the DR policy, e.g., the next day.

It is noted that no additional pieces of media are often required to accommodate the missing data objects in the second set of media 160a. For example, the newly ingested data objects on the second set of media 160a may occupy less storage space than is provided on a single tape, and the missing data objects from the earlier shipment can be added without having to provide any additional tape. Even when the newly ingested media take up multiple tapes, it is often possible to add the missing data objects from the earlier shipment to a partially filled tape, without having to add an additional tape. Thus, rather than replacing the missing media, the instant technique aims at replacing the missing data objects, which can often be accomplished without having to provide any additional pieces of media.

Preferably, the reply list 168 also identifies each data object from the earlier shipment that is confirmed to have arrived undamaged at the second site 120. For each data object on the first set of media 160 for which the reply list 168 confirms safe arrival, the first site 110 stubs the data object, i.e., creates a pointer in the file system to the data object at the second site 120, and purges the data object itself from the disk cache. It is noted that, even after purging the data object from disk, two copies still remain, i.e., the copy at the second location 120 and the copy slated to be shipped to the third site 130.

Some customers may require that both tape copies of their data objects be confirmed to have arrived safely at their respective destinations before stubbing is allowed to take place. For this purpose, lists 166 of data objects and reply lists 168 can also be used in connection with the third site 130, or with any number of sites. Some customers require that several redundant copies of their data be maintained. Each such site, or any subset of them, can thus make use of lists 166 and reply lists 168 in accordance with the techniques described.

The use of lists 166 and reply lists 168 in the manner described, as part of a technique for managing offsite data storage, confers great benefits to customers and operators of storage sites because it avoids the need to mount and read arriving media. The amount and degree of utilization of equipment at the offsite locations can thus be reduced, along with the expense of operating and maintaining such equipment. Workflows are improved, as personnel who would otherwise spend a great deal of their time loading and verifying media are now free to perform other tasks.

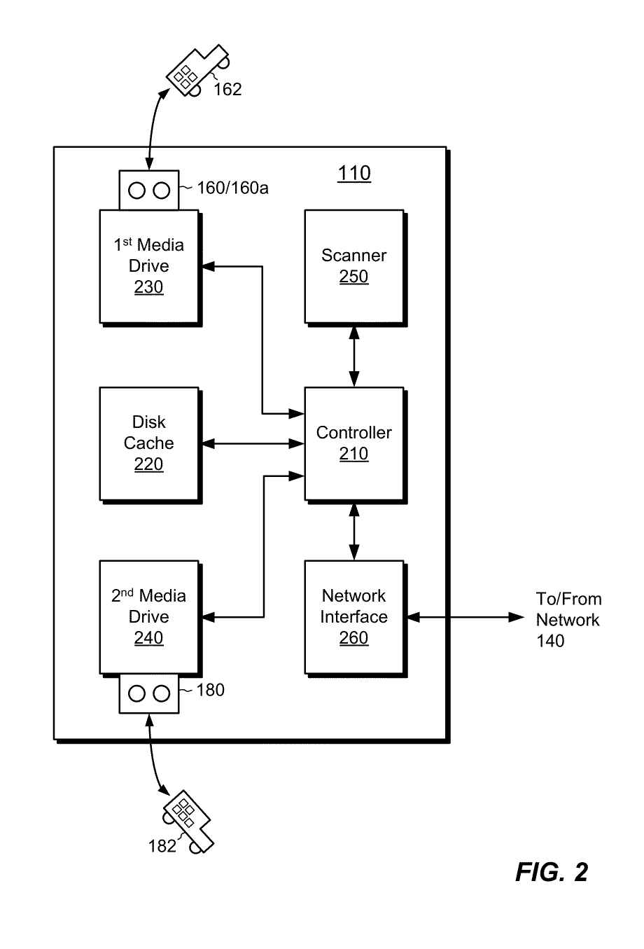

FIG. 2 shows an example arrangement of the first site 110 in additional detail. Here, it is seen that the first site 110 includes a computerized system of interconnected components, such as a controller 210, the above-described disk cache 220, a first media drive 230 (e.g., for loading the media 160/160a), a second media drive 240 (e.g., for loading the media 180), a scanner 250, and a network interface 260.

The controller 210 is a computing machine including a set of processors (i.e. one or more processing chips and/or assemblies) and memory. The controller 210 is constructed and arranged to execute computer-readable instructions stored in its memory for carrying out various processes described in connection with the first site 110. In some examples, the controller 210 is provided in the form of a computer or a set of computers. In other examples, the controller 210 is provided in the form of a mobile device.

The disk cache 220 typically includes one or more magnetic disk drives; however, it may instead be made up of other forms of non-volatile memory (tapes, flash memory, read/write optical media, and so forth, or any combination of the foregoing). The first and second media drives 230 and 240 may be provided as tape drives or drives for loading other types of storage media.

In some examples, the scanner 250 is an optical scanner configured for reading bar codes. For instance, the scanner 250 can be a special-purpose mobile computing device, connected to the controller 210 over a wireless network. In some examples, the scanner 250 is a wedge scanner connected to a local workstation, or to the controller 210 itself.

The network interface 260 is typically one or more network interface cards (NICs) connected to the network 140. In some examples, the network interface 260 includes a wireless interface for connecting to the network 140 wirelessly.

When operating the computerized system at the first site 110, data objects are ingested via the network interface 260 and stored in the disk cache 220. The data objects are then dual-written to respective pieces of media (e.g., tapes) in the first media drive 230 and in the second media drive 240. The controller 210 keeps track of each data object stored on each piece of media loaded into the first media drive 230 and into the second media drive 240. In an example, when media are unloaded from the first media drive 230 and placed onto the truck 162 (or handed off to a courier, carrier, etc.), the scanner 250 scans the media to identify each piece of media in the shipment (or multiple shipments, as the case may be). The controller 210 then creates the list 166 of data objects and sends the list, via the network interface 260, to the second site 120. Sometime later, the controller 210 receives a reply list 168, via the network interface 260, from the second site 120. The controller 210 reads the reply list 168 and copies any data objects identified as missing on the reply list 168 from the disk cache 220 to the piece of media loaded into the first media drive 230. If the piece of media in the first media drive 230 is full, the controller 210 directs another piece of media to be installed in the first media driver 230, and all pieces of media slated for shipment to the second site 120 are gathered together to form the second set of media 160a. Depending on policy, the controller 210 can stub any data objects for which the reply list 168 indicates a confirmed delivery. An analogous process may take place for the third site 130 using the second media drive 240.

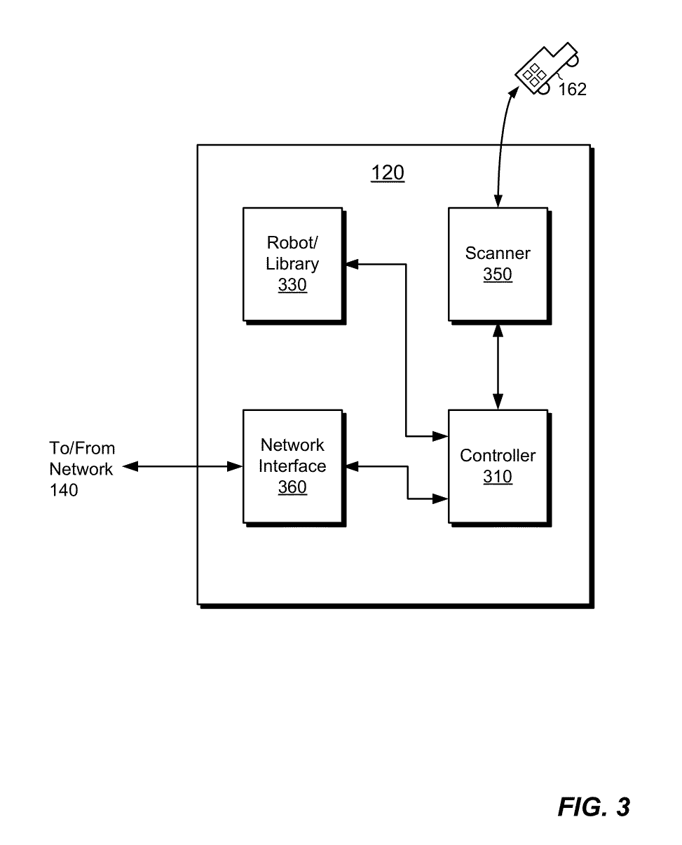

FIG. 3 shows an example arrangement of the second site 120 in additional detail. Here, it is seen that the second site 120 also includes a computerized system of interconnected components, such as a controller 310, a robot/library 330, a scanner 350, and a network interface 360. The controller 310, scanner 350, and network interface 360 can be implemented in any of the ways described in connection with the controller 210, scanner 250, and network interface 260 of FIG. 2, respectively. Here, however, the controller 310 is constructed and arranged to execute computer-readable instructions stored in its memory for carrying out various processes described in connection with the second site 120.

The robot/library 330 (sometimes called the “customer robot”), is an automated filing system for media, such as tapes, where media can be stored in a slot or drive of the robot/library 330. The robot/library 330 can include multiple drives. Each drive of the robot/library 330 is similar to the first and second media drives 230 and 240. The robot/library 330 stores an indexing system, and is able to physically retrieve media from slots and load them in drives for reading. The robot/library 330 thus allows users of machines 150 to access data objects stored at the second site 120 over the network 140 using the file system described in connection with the first site 110. Even when data objects are stubbed, and the corresponding physical media are in a slot of the robot/library 330, the robot/library 330 can obtain the physical media, load the media into drives, and return the data objects requested over the network 140. It is understood that the automatic operation of the robot/library 330 does not preclude manual intervention. Thus, it is envisioned that the robot/library 330 may operate side-by-side with manual processes, where operators receive instructions to fetch media from shelves and load the media into drives for reading. Although robot/libraries 330 are particularly well suited for use according to embodiments hereof, manual tape drives and storage techniques (e.g., placing media on physical shelves) may be used in place of robots. In further examples, specialized devices for efficiently reading and verifying tapes may be provided.

In example operation, when the first set of media 160 arrives at the second site 120 (e.g., as part of one shipment on the truck 162, as part of multiple designated shipments, and/or in shipments over a designated window of time), the scanner 350 scans each piece of media to read its media identifier (e.g., its GUID). Operators may be trained not to scan observably damaged media, or to scan them but mark them as damaged, so that they are treated the same way as missing media or perform further validation and/or remediation actions (like copying objects, if possible, onto known good media). Contemporaneously, the controller 310 receives the list 166 of data objects in the shipment. The controller 310 reads the list 166. For each piece of undamaged media of the first set of media 160 scanned by the scanner 350, the controller 310 looks up the media identifier on the list 166 and marks each corresponding data object as confirmed (e.g., by marking fields in the list 166). Once all pieces of media of the first set of media 160 arriving at the second site 120 have been scanned, the controller 310 searches the list 166 for any media identifiers that have not been marked as confirmed. Each such media identifier is then marked as missing. In addition, each data object indicated on the list 166 as having been stored on each missing piece of media is similarly marked as missing. The updated list is saved as the reply list 168 and transmitted back to the first site 110 via the network interface 360.

In some examples, the third site 130 and any additional sites are constructed similarly to the second site 120. Alternatively, if the third site 130 or other additional sites are provided merely for cold storage, certain elements, such as the robot/library 330, may be omitted.

It is understood that the lists 166 of data objects need not be sent to the second site 120 and that the reply lists 168 need not be created at the second site 120 in all implementations. According to one alternative, pieces of media making up the first set of media 160 are scanned at the first site 110 as they are being included in the first set of media 160. The scanned identifiers, along with identifiers of the data objects, the respective pieces of media store, are then sent to the database server 152, where the list 166 is stored. Along a similar vein, the reply list 168 need not be generated explicitly at the second site 120. Rather, in some examples, pieces of media arriving at the second site 120 are scanned to read their media identifiers, and the scanned media identifiers are sent to the database server 152. The database server 152, or some processor with access to the database server 152, then identifies discrepancies between expected media identifiers and those reflecting actual receipt, and provides such discrepancies in the form of reply list 168 to the first site 110, where data objects identified as missing can be included in one or more subsequent shipments.

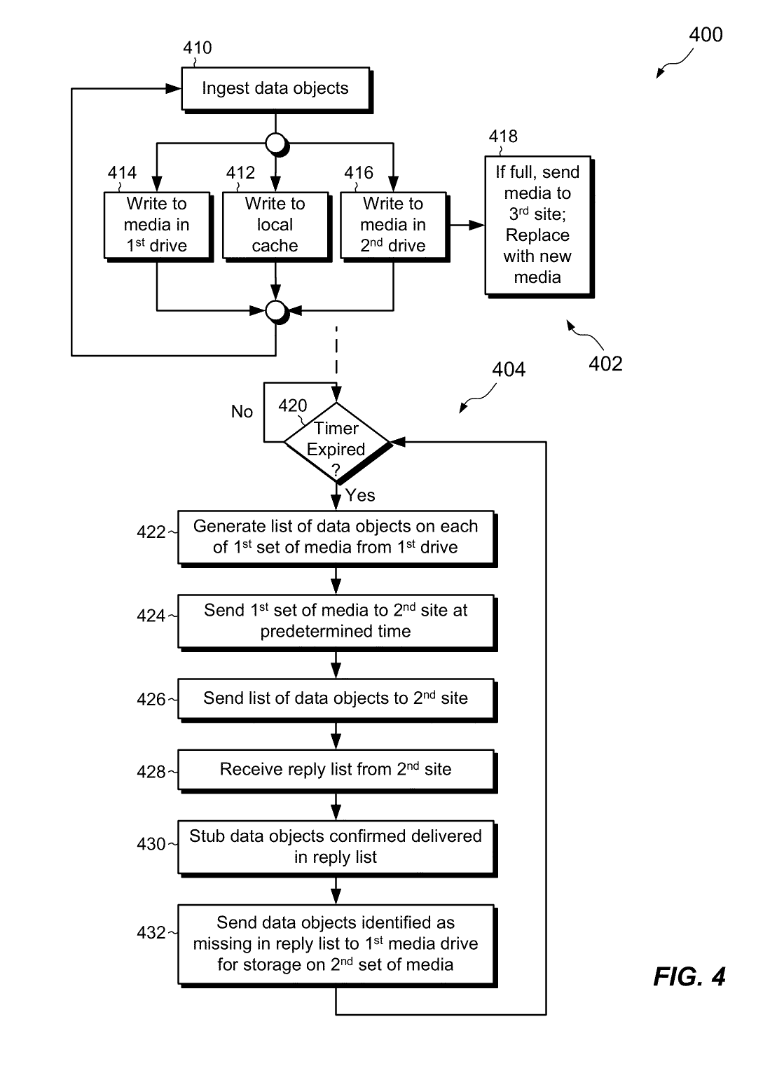

FIG. 4 illustrates an example process 400 for managing offsite storage of data objects. In an example, the process 400 is conducted by the controller 210 at the first site 110 in connection with the environment 100. The various acts of the process 400 may be ordered in any suitable way. Accordingly, embodiments may be constructed in which acts are performed in orders different from those illustrated, which may include performing some acts simultaneously, even though the acts are shown as sequential in the illustrated embodiments.

The process 400 may be regarded as including two distinct operational threads, 402 and 404. The threads 402 and 404 can run continuously and in parallel. In an example, the operational threads 402 and 404 are implemented as different processing threads running on the controller 210.

Beginning at step 410, data objects are ingested. For example, new x-ray data (or any type of data) can be taken into the first site 110 via the network interface 260. The newly ingested data objects are then typically stored in three locations. At step 412, the data objects are stored in the local disk cache 220. At step 414, the data objects are written to a piece of media (e.g., a tape) loaded in the first media drive 230. If the piece of media in the first media drive 230 becomes full, the piece of media may be replaced with another piece of media, and all such pieces of media are grouped together to form the first set of media 160. At step 416, the data objects are written to another piece of media loaded in the second media drive 240. At step 418, if the piece of media loaded in the second drive 240 becomes full, the full piece of media is sent to the third site 130 (or grouped with other pieces of media for shipment to the third site 130 at a later time). The steps 412, 414, and 416 can take place in any order, or simultaneously. Steps 410-418 may proceed continuously, with new data objects continually being ingested and stored to the disk cache 220 and to the various media.

The second thread 404 may also operate continuously. At step 420, the controller 210 refers to a timer, such as a system clock, to determine whether a time has arrived to ship the first set of media 160 to the second site 120 in accordance with the DR policy in effect, to ensure that data objects are promptly stored offsite. The thread 204 running on the controller 210 waits for the timer to expire.

When the timer expires, control proceeds to step 422, whereupon the controller 210 generates a list 166 of data objects stored in the first set of media 160. For example, each piece of media in the first set of media 160 is scanned by the scanner 250 as it is being loaded onto the truck 162. The controller 210 may apply the list of scanned pieces of media to produce the list 166 of data objects.

At step 424, the controller 210 issues a command to initiate shipment of the first set of media 160 to the second site 120. In response to this command, the first set of media 160 are loaded onto the truck 162 manually. In some examples, the first set of media 160 are loaded onto multiple trucks or transportation vehicles. Media may alternatively be provided to couriers, carriers, or other delivery means.

Contemporaneously, at step 426, the controller 210 sends the list 166 of data objects to the second site, e.g., over the network 140. Shipment of the first set of media 160 can occur at any time relative to generating the list 166 (step 422) or to sending the list 166 (step 426). The sequence shown is merely an example.

With the shipment of the first set of media 160 en route to the second site 120 and list 166 sent over the network 140, the thread 204 running on the controller 210 waits for a reply. The reply arrives at step 428 and includes the reply list 168. The controller 210 reads the reply list 168 and takes action accordingly.

At step 430, the controller 210 stubs from the disk cache 220 all data objects that the reply list 168 confirms to have arrived at the second site 120. In some examples, stubbing of confirmed data objects is delayed until confirmation of receipt is obtained from another offsite storage location, such as the third site 130, and/or additional locations.

At step 432, the controller 210 identifies missing data objects from the reply list 168. The controller 210 then slates the missing data objects for storage on a later media shipment (e.g., the second set of media 160a) being prepared for shipment to the second site 120 (e.g., to be stored in a manner similar to that described at step 414).

Control may then return to step 420, whereupon the thread 404 running on the controller 210 waits again for the timer to expire, while the thread 402 continues to ingest and store data objects in parallel with the thread 404 as described above.

An improved technique has been described for managing offsite data storage, which avoids the need for tapes or other media arriving at an offsite storage location to be mounted. The improved technique provides better utilization of media, in addition to avoiding the need for media to be mounted at the second site 120. Costs of operating offsite storage locations are therefore reduced.

As used throughout this document, the words “comprising,” “including,” and “having” are intended to set forth certain items, steps, elements, or aspects of something in an open-ended fashion. Although certain embodiments are disclosed herein, it is understood that these are provided by way of example only and the invention is not limited to these particular embodiments.

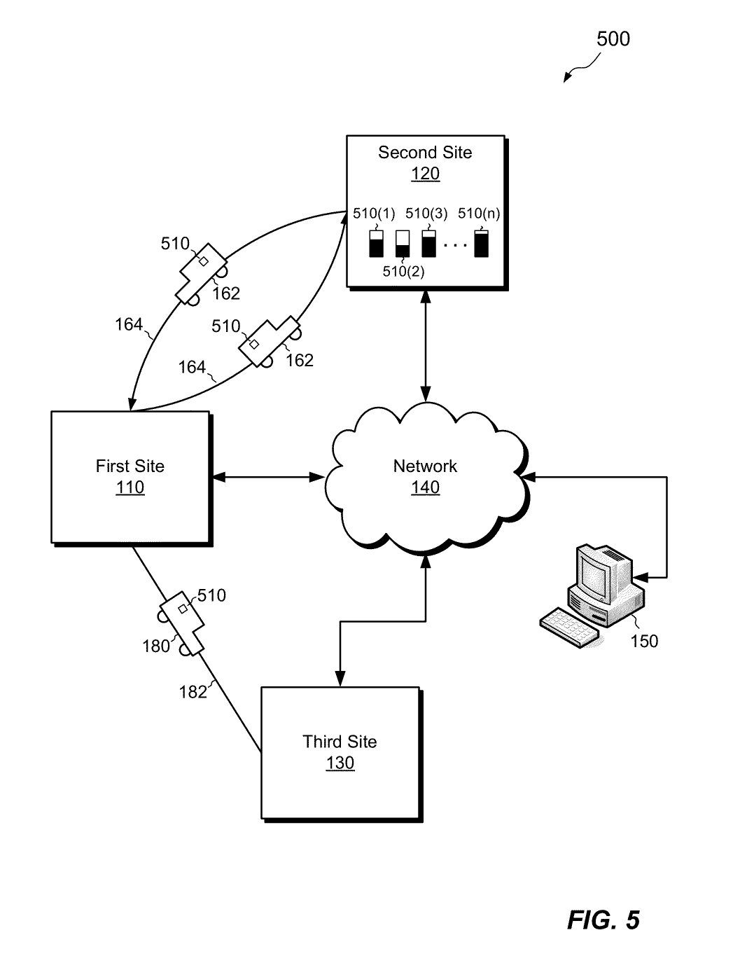

Having described certain embodiments, numerous alternative embodiments or variations can be made. For example, FIG. 5 shows a variant of FIG. 1, wherein the truck 162 (or any truck, set of trucks, or other transportation vehicles) makes regular trips along the route 164 between the first site 110 and the second site 120. The truck 162 may make numerous stops ranging over a large area; however, the truck 162 is shown only on the route 164 for the sake of simplicity.

The variant shown in FIG. 5 addresses the need to move data objects regularly off of the first site 110, e.g., in accordance with a DR policy in effect, while also attempting to more completely utilize media. Because shipments from the first site 110 to the second site 120 are based on time, rather than on when media are full, media shipped to the second site 120 are frequently poorly utilized. For example, such media may be only one-tenth or one-quarter full. The variant of FIG. 5 improves media utilization by regularly cycling pieces of media back to the first site 110, to be loaded with additional data objects.

For example, on a first day, the truck 162 conveys a piece of media 510(1) from the first site 110 to the second site 120. While the truck 162 is at the second site 120, another piece of media, 510(n), which may have been at the second site 120 for a while, is loaded on the truck 162 and returned to the first site 110. At the first site 110, the piece of media 510(n) is loaded into the first media drive 230, and additional data objects are stored on the piece of media 510(n), as previously described. When time comes for the next shipment from the first site 110 to the second site 120, the piece of media 510(n), which is better utilized, can be sent back to the second site 120 on the truck 162. The piece of media 510(n) is checked into the second site 120, and another piece of media (e.g., 510(2)) is picked up for transport back to the first site 110. This process can continue in this fashion, with different pieces of media 510(1-n) being picked up on different trips, loaded with additional data objects at the first site 110, and returned to the second site 110. The pieces of media 510(1-n) are thus cycled back and forth between the first site 110 and the second site 120, until each is substantially filled, at which point the respective piece of media typically remains in storage at the second site 120 indefinitely, or is shipped to another site for long-term storage.

For each shipment of media from the first site 110 to the second site 120, lists 166 of data objects and reply lists 168 are preferably generated, as described in connection with the process 400. In addition, a reciprocal process can take place for shipments of media from the second site 120 to the first site 110. For example, the second site 120 can generate lists 166 of data objects sent in shipments back to the first site 110, and the first site 110 can generate reply lists 168, which are sent back to the second site 120. If any pieces of media are missing from a shipment from the second site 120 to the first site 110, the first site 110 may regenerate the missing data objects, e.g., by pulling them from the disk cache 220 if the data objects are still there, or by retrieving copies of the data objects from the third site 130 or additional sites. In some examples, the second site 120 maintains its own disk cache, to store a duplicate copy of data objects on any media 510(1-n) sent back to the first site 110, and the second site 110 can regenerate any data objects missing from shipments back to the first site 110 directly, without the need to pull the data objects from cold storage. Many variations of this idea are contemplated.

Although it has been described that shipments of media among the first site 110, second site 120, and third site 130 are made using trucks, clearly any means of physically transporting the media may be employed, such as by hand or using cars, busses, trains, planes, or any type of vehicle.

Further, although the lists 166 of data objects and the reply lists 168 are shown and described as being transmitted over the Internet, this is also merely an example. Alternatively, the lists 166 and 168 can be transmitted using other means, such as fax, cell phone, or even paper. In an example, the lists 166 and 168 are provided in paper form that can be loaded on the trucks along with respective shipments.

Further, it has been shown and described that the lists 166 and reply lists 168 themselves contain lists of data objects. Alternatively, however, the lists 166 and reply lists 168 include identifiers of media (e.g., GUIDs of included media) but do not include lists of the data objects they store. Rather, the lists of data objects loaded onto the respective media are stored elsewhere, such as at the database server 152. The first site 110, upon receiving a reply list 168, can thus access the database server 152 to identify any missing data objects from the missing media indicated on the reply list 168. The first site 110 can then direct storage of any missing data objects on another set of media (e.g., on a second set of media 160a) slated for later shipment to the second site 120. Thus, it is not required that the lists 166 and reply lists 168 themselves list data objects; rather, it is sufficient that they merely list media identifiers as long as respective lists of data object can be obtained elsewhere.

Further still, the improvement or portions thereof may be embodied as a non-transient computer-readable storage medium, such as a magnetic disk, magnetic tape, compact disk, DVD, optical disk, flash memory, Application Specific Integrated Circuit (ASIC), Field Programmable Gate Array (FPGA), and the like (shown by way of example as medium 450 in FIG. 4). Multiple computer-readable media may be used. The medium (or media) may be encoded with instructions which, when executed on one or more computers or other processors of the controller 210, perform methods that implement the various processes described herein. Such medium (or media) may be considered an article of manufacture or a machine, and may be transportable from one machine to another.

Those skilled in the art will therefore understand that various changes in form and detail may be made to the embodiments disclosed herein without departing from the scope of the invention.

What is claimed is:

1. A method of managing shipments of data storage media between different sites, comprising:
generating a list of data objects stored on a first set of media, the list of data objects identifying, for each data object, the particular piece of media of the first set of media on which the respective data object is stored;
sending, via physical transportation, the first set of media from a first site to a second site;
receiving a reply list that indicates which data objects from the list of data objects were missing at the second site, based on which pieces of media of the first set of media did not arrive at the second site or arrived but in an observably damaged condition; and
storing, on a second set of media to be physically transported from the first site to the second site, additional data objects, as well as each data object indicated as missing in the received reply list.

2. The method of claim 1, wherein the data objects indicated as missing fit on the second set of media along with the additional data objects without requiring any additional pieces of media specifically to accommodate the data objects indicated as missing.

3. The method of claim 2, wherein, when receiving the reply list, the reply list also indicates pieces of media received at the second site that were not listed on the list of data objects.

4. The method of claim 2, further comprising storing the list of data objects in a database and storing the reply list in the database, wherein the database is electronically accessible by the first site and the second site.

5. The method of claim 4, wherein each piece of media of the first set of media has an identifying code, and wherein generating the list of data objects includes scanning the identifying code applied to each piece of media of the first set of media at the first site and transferring the scanned codes to the database.

6. The method of claim 5, wherein receiving the reply list includes receiving a list of data objects missing at the second site from the database, wherein the database has received codes scanned from the pieces of media that arrived at the second site.

7. The method of claim 1, further comprising, prior to sending the first set of media from the first site to the second site, ingesting the data objects at the first site and storing the data objects in a local cache, wherein the data objects are accessible in the local cache through a file system.

8. The method of claim 7, wherein the received reply list further indicates which of the data objects stored on the first set of media were received at the second site, and wherein the method further comprises:
stubbing, in the file system in response to receiving the reply list, each data object indicated as received in the reply list.

9. The method of claim 7, further comprising, after ingesting the data objects:
storing the data objects on the first set of media at the first site; and
storing the data objects on a third set of media at the first site contemporaneously with storing the data objects on the first set of media.

10. The method of claim 9, wherein sending the first set of media from the first site to the second site takes place at a predetermined time, prior to all pieces of media of the first set of media being substantially filled.

11. The method of claim 10, further comprising sending the third set of media from the first site to a third site after all pieces of media of the third set of media have been substantially filled.

12. The method of claim 11, further comprising:
storing the data objects on at least one additional set of media at the first site; and
sending each additional set of media from the first site to at least one additional site after all pieces of media of the respective additional set of media are substantially filled.

13. The method of claim 1, wherein the received reply list further indicates which of the data objects stored on the first set of media were received at the second site, and wherein the method further comprises:
storing the data objects on a third set of media at the first site;
sending, via physical transportation, the third set of media storing the data objects from the first site to a third site;
generating a second list of data objects stored on the third set of media;
receiving a second reply list indicating which data objects indicated on the second list of data objects were received at the third site; and
stubbing, in a file system operated at the first site, each data object indicated as received on the reply list and also indicated as received on the second reply list.

14. The method of claim 1, further comprising:
receiving a piece of media of the first set of media back to the first site from the second site;
storing further data objects on the piece of media at the first site; and
sending, via physical transportation, the piece of media back to the second site.

15. The method of claim 14, further comprising:
continuing to transport the piece of media between the first site and the second site and adding yet further data objects each time the piece of media returns to the first site until the piece of media becomes substantially filled; and
once the piece of media becomes substantially filled, transporting the piece of media from the first site to another site for storage at the other site.

16. The method of claim 1, further comprising the reply list indicating that a data object stored on the first set of media is missing in response to the piece of media associated with the data object not arriving at the second site within a predetermined window of time.

17. The method of claim 1, wherein sending the first set of media from the first site to the second site is conducted in multiple designated shipments of pieces of media from the first site to the second site.

18. A method of managing shipments of data storage media between different sites, comprising:
receiving a list of the data objects stored on a first set of media, wherein the list of data objects associates each data object on the list with a particular piece of media of the first set of media;
receiving, via physical transportation, the first set of media sent from a first site to a second site;
generating a reply list that indicates which data objects from the list of data objects were missing, based on which pieces of media of the first set of media did not arrive at the second site or arrived but in a visibly damaged condition;
sending the reply list to the first site; and
receiving, on a second set of media physically transported from the first site to the second site at a later time, additional data objects, as well as each data object indicated as missing in the received reply list.

19. The method of claim 18, wherein the data objects indicated as missing fit on the second set of media along with the additional data objects without requiring any additional pieces of media to specifically accommodate the data objects indicated as missing.

20. The method of claim 18,
wherein each piece of media in the first set of media has a media identifier,
wherein the list of data objects includes, for each piece of media, the media identifier of the piece of media and an associated sub-list of data objects stored on the piece of media, and
wherein the method further comprises scanning each piece of media of the first set of media received at the second site to read the media identifier from the respective piece of media.

21. The method of claim 18, wherein generating the reply list includes indicating that a data object is missing when none of the media identifiers read by scanning the pieces of media is associated with a sub-list in the list of data objects that includes the data object.

22. The method of claim 21, wherein the list of data objects is received from the first site over a network, and wherein the reply list is sent from the second site to the first site over the network.

23. The method of claim 22, further comprising receiving a piece of media that is not part of the first set of media and whose data objects are not included on the received list of data objects, wherein generating the reply list includes adding to the reply list an identifier of the received piece of media that is not part of the first set of media.

24. A computerized system for managing shipments of data storage media between different sites, comprising:
a controller; and
a media drive,
wherein the controller is constructed and arranged to:
generate a list of data objects stored on a first set of media, the list of data objects identifying, for each data object, the particular piece of media of the first set of media on which the respective data object is stored;
issue a command to send, via physical transportation, the first set of media from a first site to a second site;
receive a reply list that indicates which data objects from the list of data objects were missing at the second site, based on which pieces of media of the first set of media did not arrive at the second site or arrived but in an observably damaged condition; and
direct the media drive to store, on a second set of media to be physically transported from the first site to the second site, additional data objects, as well as each data object indicated as missing in the received reply list.

25. The computerized system of claim 24, further comprising a local cache, wherein the received reply list further indicates which of the data objects stored on the first set of media were received at the second site, and wherein the controller is further constructed and arranged to:
provide access to the data objects in the local cache via a file system; and
stub, in the file system, each data object indicated as received in the reply list.

26. The computerized system of claim 24, further comprising a scanner, wherein the controller is further constructed and arranged to:
receive a scanned identifier from the scanner of a piece of media of the first set of media received back to the first site from the second site;
store further data objects on the piece of media at the first site; and
issue a command to send, via physical transportation, the piece of media back to the second site when the piece of media remains unfilled after storing the further data objects.

27. A non-transitory computer readable medium including instructions which, when executed by a controller of a computerized system, cause the controller to perform a method for managing shipments of data storage media between different sites, the method comprising:
generating a list of data objects stored on a first set of media, the list of data objects identifying, for each data object, the particular piece of media of the first set of media on which the respective data object is stored;
issuing a command to send, via physical transportation, the first set of media from a first site to a second site;
receiving a reply list that indicates which data objects from the list of data objects were missing at the second site, based on which pieces of media of the first set of media did not arrive at the second site or arrived but in an observably damaged condition; and
storing, on a second set of media to be physically transported from the first site to the second site at a later time, additional data objects, as well as each data object indicated as missing in the received reply list.
